(19) United States
(12) Patent Application Publication
(10) Pub. No.: US 2026/0206889 A1
(43) Pub. Date: Jul. 23, 2026

(54) PERMEATION RESISTANT GLOVE

(71) Applicant: Hartalega Research Sdn Bhd, Selangor (MY)

(72) Inventors: Mei Yuin Joanne WEE, Selangor (MY); Wei Kit CHEE, Selangor (MY); Kam Hon @ Kwan Kam Onn KUAN, Selangor (MY); Mun Leong KUAN, Selangor (MY); Eu Jin KUAN, Selangor (MY); Mei Ling CHEAH, Selangor (MY)

(21) Appl. No.: 19/144,340

(22) PCT Filed: Apr. 27, 2023
(86) PCT No.: PCT/MY2023/050028

§ 371 Date: Jun. 27, 2025

(30) Foreign Application Priority Data
Dec. 28, 2022 (MY) PI2022007489

(51) Int. Cl. A41D 19/00; C08K 3/014; C08K 3/06; C08K 3/11; C08K 3/22; C08K 3/34; C08K 5/205; C08K 5/42; C08L 9/04

(52) U.S. Cl. CPC A41D 19/0055; C08K 3/014; C08K 3/06; C08K 3/11; C08K 3/22; C08K 3/346; C08K 5/205; C08K 5/42; C08L 9/04; C08K 2003/2241

(57) ABSTRACT

A latex formulation having an additive comprising a manganese based compound, wherein the manganese in the additive is with valency of +2 or +7, wherein the additive having the manganese with valency +2 is used in an amount ranging between 0.005 phr to 30.0 phr; and wherein the additive having the manganese with valency +7 is used in an amount ranging between 0.25 phr to 10.0 phr. A latex formulation having an additive comprising manganese based compound, wetting agent, dispersing agent, thickener and water.

### FIELD OF THE INVENTION

The present invention relates to a latex formulation and method of manufacturing thereof, in particular the latex formulation of the present invention is prepared by incorporating an additive which is subsequently used to produce gloves exhibiting desirable chemical permeation resistance properties as well as physical appearance without compromising the mechanical properties.

### BACKGROUND OF THE INVENTION

Workplace safety refers to the working environment at a company and encompasses all factors that influence the safety, health and well-being of employees. Exposure to chemicals commonly used in workplaces can lead to a variety of short-term and long-term health effects. With the increase in awareness of the importance of safety in the workplace, more people are paying attention to the level of protection offered by the personal protective equipment (PPE) that they are using.

Gloves offer protection to the user's hands while handling chemicals. Since lightweight gloves are well-known in the market, maintaining similar degree of protection of gloves for the user would be a challenge. Additionally, the chemical added as an additive to resist the permeation of hydrogen peroxide must not interfere with the desired glove colour.

WO 2022031163 relates to a nitrile glove with improved permeation resistance wherein the nitrile glove comprises manganese dioxide. However, the inclusion of manganese dioxide is found to modify the colour of the resultant glove and longer time is taken for the purpose of milling the manganese dioxide which is undesirable.

As such, an approach is developed to identify an additive that can be incorporated into a latex formulation that can be subsequently used to produce a glove exhibiting desirable chemical permeation resistance properties as well as physical appearance without compromising the mechanical properties.

### SUMMARY OF THE INVENTION

The present invention relates to a latex formulation having an additive comprising manganese based compound, wherein the manganese in the additive is with valency of +2 or +7, wherein the additive having the manganese with valency +2 is used in an amount ranging between 0.005 phr to 30.0 phr; and wherein the additive having the manganese with valency +7 is used in an amount ranging between 0.25 phr to 10.0 phr.

The present invention further relates to a latex formulation having an additive comprising manganese based compound, wherein the manganese based compound is used in an amount ranging between 5.0 wt % to 40.0 wt % of the additive; wetting agent, wherein the wetting agent is used in an amount ranging between 1.0 wt % to 5.0 wt % of the additive; dispersing agent, wherein the dispersing agent is used in an amount ranging between 0.02 wt % to 2.0 wt % of the additive; thickener, wherein the thickener is used in an amount ranging between 3.0 wt % to 15.0 wt % of the additive; and water, wherein the water is used in an amount ranging between 38.0 wt % to 90.98 wt % of the additive.

Additional aspects, features and advantages of the invention will become apparent to those skilled in the art upon consideration of the following detailed description of the accompanying drawings and preferred embodiments of the invention.

### BRIEF DESCRIPTION OF THE ACCOMPANYING DRAWINGS

The present invention will be fully understood from the detailed description given herein below and the accompanying drawings which are given by way of illustration only, and thus are not limitative of the present invention, wherein:

In the attached drawings:

FIG. 1a represents the results of field-emission scanning electron microscope (FESEM) analysis for conventional glove.

FIG. 1b represents the results of field-emission scanning electron microscope (FESEM) analysis for the glove of the present invention having 0.05 phr of manganese carbonate as additive.

FIG. 1c represents the results of field-emission scanning electron microscope (FESEM) analysis for the glove of the present invention having 15.0 phr of manganese carbonate as additive.

FIG. 2a represents the results of permeation breakthrough time (BTT) for a conventional glove.

FIG. 2b represents the results of permeation breakthrough time (BTT) for gloves of the present invention having 0.15 phr, 0.25 phr, 0.5 phr, 1.0 phr and 4.0 phr of manganese carbonate as additive of the present invention.

FIG. 2c represents the results of permeation breakthrough time (BTT) for glove of the present invention having 0.25 phr of manganese carbonate as additive of the present invention.

FIG. 2d represents the results of permeation breakthrough time (BTT) for glove of the present invention having 0.05 phr of manganese carbonate as additive of the present invention.

FIG. 2e represents the results of permeation breakthrough time (BTT) for glove of the present invention having 0.005 phr of manganese carbonate as additive of the present invention.

FIG. 3a represents the results of permeation breakthrough time (BTT) for glove of the present invention having 0.5 phr of the additive solution having potassium permanganate of the present invention.

### DETAILED DESCRIPTION OF THE INVENTION

Detailed description of preferred embodiments of the present invention is disclosed herein. It should be understood, however, the embodiments are merely exemplary of the present invention, which may be embodied in various forms. Therefore, the details disclosed herein are not to be interpreted as limiting, but merely as the basis for the claims and for teaching one skilled in the art of the invention. The numerical data or ranges used in the specification are not to be construed as limiting.

The present invention relates to a latex formulation and method of manufacturing thereof, in particular the latex formulation of the present invention is prepared by incorporating an additive which is subsequently used to produce gloves exhibiting chemical permeation resistance properties as well as physical appearance without compromising the mechanical properties.

### Additive of the Present Invention

For the purpose of the present invention, the manganese used in the present invention is with valency of +2 and +7.

First aspect of the present invention discusses on manganese carbonate as additive of the present invention.

Table 1 shows the chemical components and compositions thereof used in preparing manganese carbonate as additive of the present invention.

TABLE 1
Chemical components and compositions thereof used in the
manganese carbonate as additive of the present invention

| Chemical | Working range | Preferred range | Typical value |
|---|---|---|---|
| components | (wt %) | (wt %) | (wt %) |
| Manganese based | 5.0 to 40.0 | 15.0 to 30.0 | 20.0 |
| compound | | | |
| Wetting agent | 1.0 to 5.0 | 1.0 to 4.0 | 1.5 |
| Dispersing agent | 0.02 to 2.0 | 0.02 to 0.1 | 0.02 |
| Thickener | 3.0 to 15.0 | 5.0 to 7.0 | 5.0 |
| Water | 38.0 to 90.98 | 58.9 to 78.98 | 73.48 |

Table 2 shows the particle size of the manganese carbonate as additive of the present invention.

TABLE 2
Particle size distribution of the manganese carbonate
as additive of the present invention

| Particle Size | After stirring with | After |
|---|---|---|
| Distribution | dissolver (μm) | milling (μm) |
| D10 | 35.84 | 0.72 |
| D50 | 55.93 | 1.03 |
| D90 | 84.80 | 1.54 |
| Average | 58.65 | 1.09 |

Based on Table 2, the particle size distribution of the additive for D90 shows that it is 1.54 μm after milling, indicating that 90% of the sample has a particle size distribution of equal to or less than 1.54 μm after milling. Separately, the particle size distribution of the additive for D50 shows that it is 1.03 μm after milling, indicating that 50% of the sample has a particle size distribution of equal to or less than 1.03 μm after milling. On the other hand, the particle size distribution of the additive for D10 shows that it is 0.72 μm after milling, indicating that 10% of the sample has a particle size distribution of equal to or less than 0.72 μm after milling.

A method of preparing manganese carbonate as additive of the present invention, wherein the method comprising the steps of:
i. mixing wetting agent with water to produce a first mixture, wherein the wetting agent is selected from the group consisting of non-ionic and anionic wetting agent; ethoxylates of alcohol and mixtures thereof, preferably non-ionic acetylenic diol-based wetting agent, wherein the wetting agent is used in an amount ranging between 0.02 wt % to 2.0 wt %, preferably 0.02 wt % to 0.1 wt %, more preferably 0.02 wt % of the additive and wherein the water is soft water and water is used in an amount ranging between 38.0 wt % to 90.98 wt %, preferably 58.9 wt % to 78.98 wt %, more preferably 73.48 wt % of the additive;
ii. adding manganese based compound, dispersing agent and thickener into the first mixture obtained from step (i) to produce a second mixture, wherein the manganese based compound is used in an amount ranging between 5.0 wt % to 40.0 wt %, preferably 15.0 wt % to 30.0 wt %, more preferably 20.0 wt % of the additive, wherein the manganese based compound is manganese (II) carbonate, wherein the manganese based compound is used in a powder form, wherein the manganese based compound has an average particle size ranging between 10.91 μm to 70.32 μm, wherein the dispersing agent is selected from the group consisting of non-ionic and anionic dispersing agent, wherein the dispersing agent is used in an amount ranging between 1.0 wt % to 5.0 wt %, preferably 1.0 wt % to 4.0 wt %, more preferably 1.5 wt % of the additive, wherein the thickener is selected from the group consisting of xanthan gum, guar gum, bentonite and mixtures thereof, preferably bentonite and wherein the thickener is used in an amount ranging between 3.0 wt % to 15.0 wt %, preferably 5.0 wt % to 7.0 wt %, more preferably 5.0 wt % of the additive; and
iii. milling the second mixture obtained from step (ii) by using the wet ball milling for a duration ranging between 30 minutes to 60 minutes at a speed ranging between 800 rpm to 1600 rpm to produce the additive of the present invention.

The final total solid content of the additive of the present invention is 20% by weight with an average particle size ranging between 0.1 μm to 7.0 μm, preferably 0.5 μm to 2.5 μm.

For the purpose of the present invention, the term “soft water” can be defined as water that may contain trace amounts of dissolved minerals such as but not limited to calcium and magnesium.

Second aspect of the present invention discusses on potassium permanganate (also known as potassium permanganate (VII)) as an additive to be used in a latex formulation. The potassium permanganate as an additive is used in the form of aqueous solution, wherein the potassium permanganate is used in an amount of 0.5 phr while the remaining is water to prepare the aqueous solution as additive.

### Latex Formulation of the Present Invention

Third aspect of the present invention discusses on a latex formulation having the manganese carbonate as additive of the present invention that has been disclosed above.

Table 3 shows the chemical components and compositions thereof used in the latex formulation of the present invention.

TABLE 3
Chemical components and compositions thereof used
in the latex formulation of the present invention

| | | Working range | Preferred range |
|---|---|---|---|
| Chemical components | | (*phr) | (*phr) |
| Acrylonitrile butadiene (NBR) latex | | 100 | 100 |
| Additive | Manganese | 0.005 to 30.0 | 0.05 to 0.1 |
| | carbonate | | |
| | Potassium | 0.25 to 10.0 | 0.50 to 1.0 |
| | permanganate | | |

| | | |
|---|---|---|
| Sodium dodecyl benzene sulphonate | 0 to 0.5 | 0 to 0.4 |
| (SDBS) | | |
| Carbamate-based accelerator | 0.5 to 2.0 | 0.5 to 1.0 |
| Sulphur | 0.5 to 2.0 | 0.5 to 2.0 |
| Titanium dioxide | 0.5 to 2.5 | 1.5 to 2.0 |
| Antioxidant | 0 to 15.0 | 0 to 2.0 |

*parts per hundred rubber

A method of preparing the latex formulation having additive of the present invention comprises:
i. mixing the chemical components (as disclosed in Table 3) into the NBR latex in accordance with the compositional proportion given for the latex to produce a first compounded latex formulation;
ii. stirring the compounded latex formulation obtained from step (i) while performing pH adjustment to ensure that the pH of the latex formulation is ranging between pH 8 to pH 12 by adding ammonia to produce a second compounded latex formulation; and
iii. adding the additive of the present invention into the second compounded latex formulation obtained from step (ii) while maintaining a desired concentration to yield the latex formulation of the present invention.

### Glove of the Present Invention

The glove of the present invention is manufactured by adopting a commonly known method in the glove manufacturing industry such as but not limited to chlorinated glove, powdered glove and polymer coated glove, wherein the method comprises the steps of:
i. cleaning a former to produce a cleaned former, wherein the first step is treatment using acidic solutions such as but not limited to nitric acid, the second step is treatment using alkaline solutions such as but not limited to aqueous sodium hydroxide solution, the third step is rinsing with hot water and the fourth step is drying to ensure the former surface is cleaned;
ii. dipping the cleaned former obtained in step (i) into a coagulant solution at a temperature ranging between 55° C. to 60° C. to coat a coagulant layer on the former, wherein the coagulant solution is such as but not limited to 10 wt % to 20 wt % of calcium nitrate;
iii. drying the coagulant layer coated on the former obtained in step (ii) at a temperature ranging between 55° C. to 65° C. to obtain a dried coagulant layer;
iv. dipping the dried coagulant layer coated on the former obtained in step (iii) into the latex dipping tank containing latex formulation (as summarized in Table 3) at a temperature ranging between 40° C. to 60° C. to coat a latex layer on the former at a final thickness ranging between 0.05 mm to 0.20 mm;
v. drying the latex layer coated on the former obtained in step (iv) at a temperature ranging between 80° C. to 150° C. to obtain dried latex film;
vi. pre-leaching the dried latex film coated on the former obtained in step (v) with hot water at a temperature ranging between 40° C. to 60° C. to leach out chemical residues to obtain pre-leached latex film;
vii. vulcanizing the pre-leached latex film coated on the former obtained in step (vi) by heating at a temperature ranging between 80° C. to 150° C. to leach out chemical residues to obtain glove of the present invention;
viii. chlorinating the glove of the present invention obtained in step (vii) to obtain a treated glove of the present invention;
ix. neutralizing the chlorinated glove obtained in step (viii) with alkaline treatment and water to leach out chemical residues to obtain neutralized glove of the present invention;
x. drying the neutralized glove of the present invention coated on the former obtained in step (ix) to produce glove; and
xi. stripping the glove obtained in step (x) from the former.

The following example is constructed to illustrate the present invention in a non-limiting sense.

The NBR glove of the present invention is prepared using the latex formulation as described in Table 3 adopting a method commonly known in the glove manufacturing industry.

### Test Results for the Glove of the Present Invention

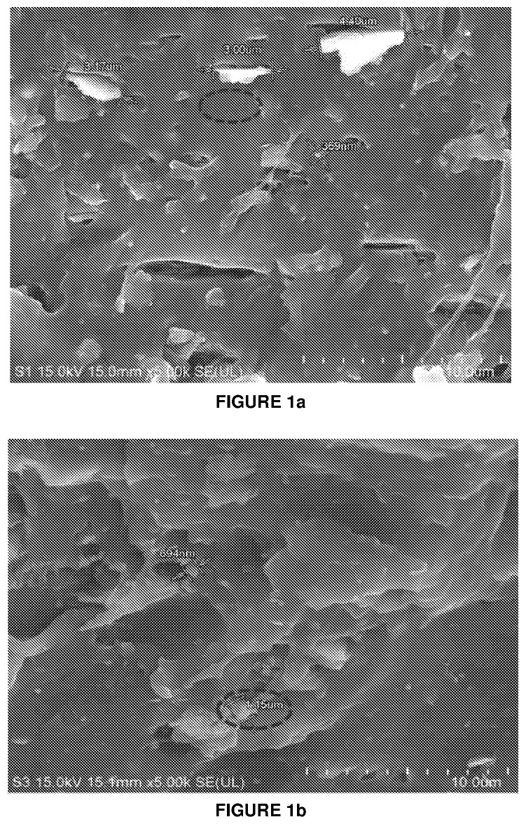

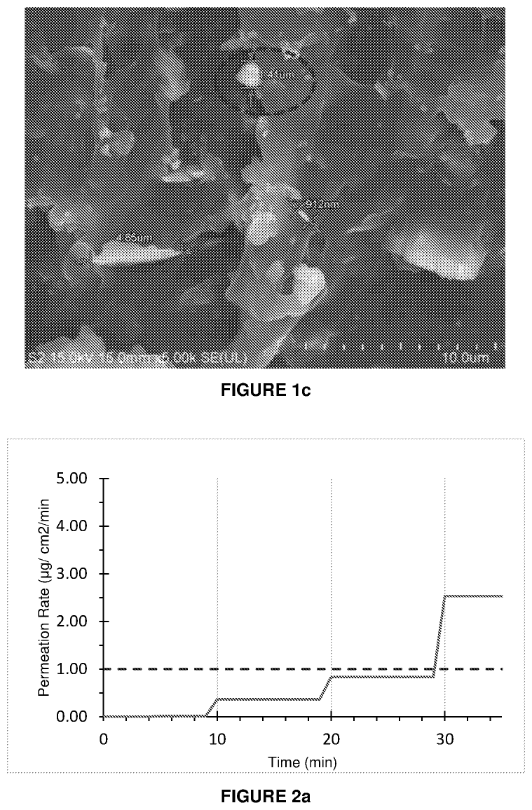

Cross-sectional samples of a conventional glove and the gloves of the present invention have been subjected to FESEM analysis, results of which are displayed as FIGS. 1a to 1c. Based on the results obtained, it is observable in FIGS. 1b and 1c that there is an increase in the manganese content when higher dosage of additive is used (as indicated in the circles in FIGS. 1b and 1c).

Further, energy dispersive X-ray (EDX) analysis was conducted on the conventional glove and the gloves of the present invention to detect the presence of manganese particles in the gloves of the present invention.

Table 4 shows the data of EDX analysis conducted on the conventional glove and the gloves of the present invention. For the purpose of table 4, Set 1 refers to a conventional glove. Set 2 refers to glove of the present invention having 0.05 phr of manganese carbonate as additive of the present invention. Set 3 refers to glove of the present invention having 15.0 phr of the manganese carbonate as additive of the present invention.

TABLE 4
Data of EDX analysis conducted on the conventional
glove and the gloves of the present invention

| | Amount of manganese |
|---|---|
| Samples | detected (atomic %) |
| Set 1 | 0 |
| Set 2 | 0.02 |
| Set 3 | 5.42 |

As displayed in Table 4, results show that there is an increase in manganese content when higher dosage of manganese carbonate as additive of the present invention is used.

As per the standard specification in EN 16523-1: 2016+A1: 2018, the permeation resistance of a glove towards challenge chemicals is measured according to the duration, whereby the gloves are able to prevent the permeation of the chemicals. This is measured by recording the breakthrough time (BTT), whereby it should not exceed 1.0 g/cm²/min. The time point where the chemicals exceed this BTT will determine the level of permeation performance of the gloves. For the purpose of the present invention, the permeation performance level is summarized in Table 5.

TABLE 5
Permeation Performance Level

| Measured breakthrough | Permeation |
|---|---|
| time (Min) | performance level |
| More than 10 | 1 |
| More than 30 | 2 |
| More than 60 | 3 |
| More than 120 | 4 |
| More than 240 | 5 |
| More than 480 | 6 |

These levels should also be assessed by the method specified in EN ISO 374-1. There are 18 challenge chemicals involved and there are 3 levels of glove performance which includes type A, B and C. The highest chemical resistance in the glove permeation classification is Type A, wherein the gloves can resist 6 out of the 18 chemicals for a duration of more than 30 minutes. Type B gloves can resist 3 types of chemicals for a duration of more than 30 minutes whereas Type C gloves can only resist 1 type of chemical for a duration of more than 10 minutes. For the purpose of the present invention, the classification of glove permeation is summarized in Table 6.

TABLE 6
Classification of Glove Permeation

| Glove Permeation | Permeation | Number of challenge |
|---|---|---|
| Classification | Performance Level | chemicals to pass |
| Type A | 2 (more than 30 minutes) | 6 |
| Type B | 2 (more than 30minutes) | 3 |
| Type C | 1 (more than 10 minutes) | 1 |

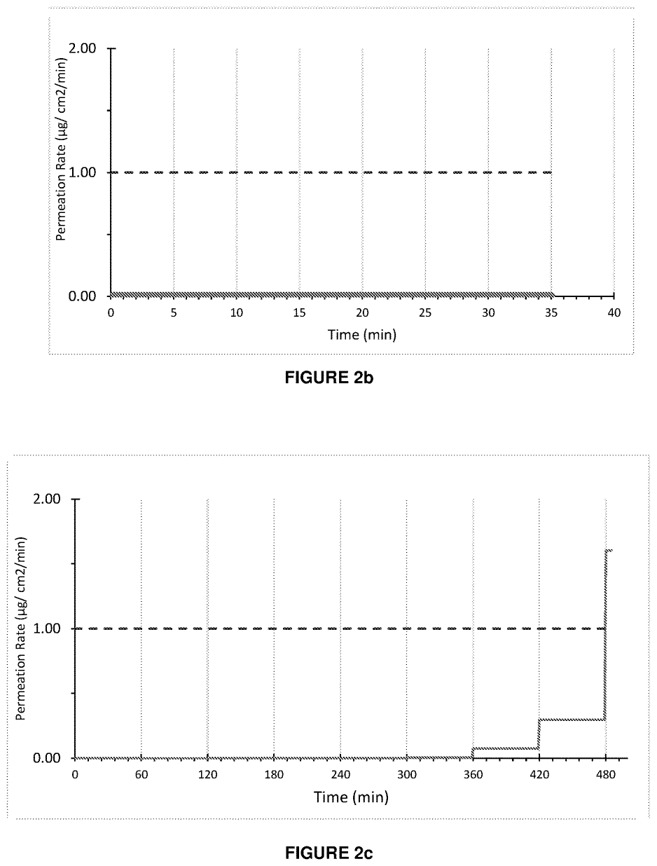

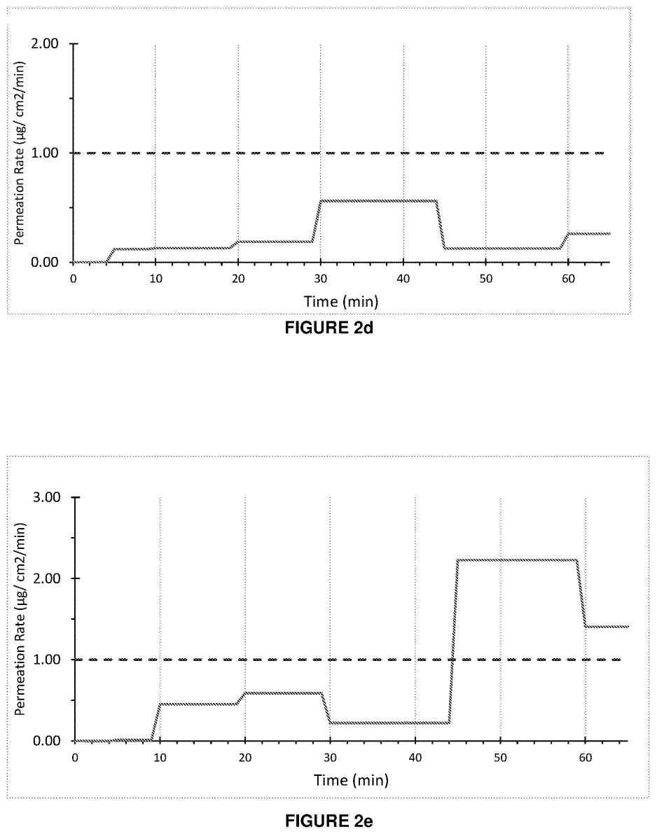

The permeation performance test is carried out for the conventional glove and glove of the present invention to determine the breakthrough time (BTT) of 30% hydrogen peroxide (H₂O₂). The results of the permeation performance are displayed in FIGS. 2a to 2e.

FIG. 2a displays the outcome of BTT for conventional glove, which is ranging between 20 minutes to 30 minutes, indicating a Level 1 permeation performance. On the other hand, FIG. 2b displays the outcome of BTT for gloves of the present invention having 0.15 phr, 0.25 phr, 0.50 phr, 1.0 phr and 4.0 phr of the manganese carbonate as additive of the present invention. Result from FIG. 2b shows desirable resistance towards the permeation of H₂O₂, wherein no permeation was detected after 30 minutes, indicating a Level 2 or higher permeation performance.

FIG. 2c displays the further outcome of BTT for glove of the present invention having 0.25 phr of the manganese carbonate as additive of the present invention, which shows that even after 7 hours or 420 minutes, the BTT of 1.0 μg/cm²/min was not reached. This indicates that even when the manganese carbonate as additive of the present invention is used in an amount of 0.25 phr, it gives significant protection to the user's hands for up to 7 hours of donning.

FIG. 2d displays the outcome of BTT for gloves of the present invention having 0.05 phr of the manganese carbonate as additive of the present invention, which is more than 60 minutes, indicating a Level 3 permeation performance. Additionally, FIG. 2e displays the outcome of BTT for gloves of the present invention having 0.005 phr of the manganese carbonate as additive of the present invention, which is more than 30 minutes, indicating a Level 2 permeation performance. Both outcomes displayed in FIGS. 2d and 2e show that even when the glove of the present invention has extremely low dosage of the manganese carbonate as additive of the present invention, a permeation performance of Level 2 and Level 3 can be achieved.

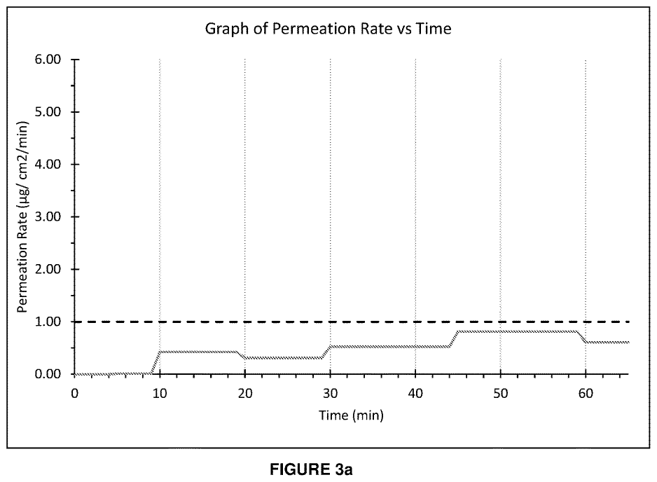

FIG. 3a displays the outcome of BTT for glove of the present invention having 0.5 phr of the potassium permanganate additive solution of the present invention as disclosed in the second aspect. Results shows that the permeation resistance exceeds Level 2 performance.

For the purpose of Table 7, Set 1 refers to NBR glove without the manganese carbonate as additive of the present invention. Set 2 refers to NBR glove prepared from latex formulation having 0.01 phr of manganese carbonate as additive of the present invention. Set 3 refers to NBR glove prepared from latex formulation having 0.05 phr of manganese carbonate as additive of the present invention. Set 4 refers to NBR glove prepared from latex formulation having 0.5 phr of manganese carbonate as additive of the present invention. Still, for the purpose of Table 7, antioxidant is absent for the sets of the present invention.

Table 7 shows the outcome of mechanical properties (i.e. tensile strength and elongation at break) for conventional glove and gloves of the present invention having the manganese carbonate as additive of the present invention in accordance to the ASTM D6319 standard. The aging condition is carried out at 70° C. for 7 days.

TABLE 7
Mechanical properties of glove samples

| | |
|---|---|
| Tensile | Elongation |
| strength (MPa) | at break (%) |

| | Before | After | Before | After |
|---|---|---|---|---|
| Samples | aging | aging | aging | aging |
| Set 1 | 35.27 | 35.28 | 534.75 | 458.65 |
| Set 2 | 34.99 | 37.09 | 603.32 | 503.90 |
| Set 3 | 32.95 | 38.84 | 621.08 | 622.98 |
| Set 4 | 34.15 | 34.96 | 543.50 | 480.31 |

| | | | |
|---|---|---|---|
| Standard | Min. 14 | Min. 500 | Min. 400 |
| requirement | | | |

Based on the table above, it is evident that sets 2 to 4 appear to meet the standard requirement for both elongation break and tensile strength.

For the purpose of Table 8, Set 1 refers to NBR glove without the manganese carbonate as additive of the present invention. Set 2 refers to NBR glove prepared from latex formulation having 5 phr of antioxidant and 15 phr of the manganese carbonate as additive of the present invention. Set 3 refers to NBR glove prepared from latex formulation having 10 phr of antioxidant and 15 phr of the manganese carbonate as additive of the present invention. Set 4 refers to NBR glove prepared from latex formulation having 15 phr of antioxidant and 15 phr of the manganese carbonate as additive of the present invention.

Table 8 shows the outcome of mechanical properties (i.e. tensile strength and elongation at break) for conventional glove and gloves of the present invention having antioxidants and manganese carbonate as additive of the present invention in accordance to the ASTM D6319 standard. The aging condition is carried out at 70° C. for 7 days.

TABLE 8
Mechanical properties of glove samples

| | |
|---|---|
| Tensile | Elongation |
| strength (MPa) | at break (%) |

| | Before | After | Before | After |
|---|---|---|---|---|
| Samples | aging | aging | aging | aging |
| Set 1 | 34.92 | 34.43 | 539.98 | 465.00 |
| Set 2 | 29.12 | 25.92 | 584.90 | 591.09 |
| Set 3 | 32.21 | 28.19 | 563.29 | 573.86 |
| Set 4 | 31.73 | 27.74 | 531.30 | 536.56 |

| | | | |
|---|---|---|---|
| Standard | Min. 14 | Min. 500 | Min. 400 |
| requirement | | | |

Based on the table above, it is evident that sets 2 to 4 meet the standard requirement for both elongation break and tensile strength.

For the purpose of Table 9, Set 1 refers to NBR glove without the additive of the present invention. Set 2 refers to NBR glove prepared from latex formulation having 0.05 phr of manganese carbonate as additive of the present invention. Set 3 refers to NBR glove prepared from latex formulation having 0.5 phr of antioxidant and 8 phr of the additive of the present invention. Set 4 refers to NBR glove prepared from latex formulation having 2.0 phr of antioxidant and 8 phr of the additive of the present invention.

Table 9 shows the colorimetry results for the glove samples as mentioned above. The aging condition is carried out at 70° C. for 7 days.

TABLE 9
Colorimetry results for glove samples

| | Before aging | | | After aging | | |
|---|---|---|---|---|---|---|
| Parameters | L* | a* | b* | L* | a* | b* |
| Set 1 | 90.85 | 0.35 | 4.71 | 90.76 | 0.23 | 5.71 |
| Set 2 | 90.87 | 0.43 | 5.44 | 90.84 | 0.16 | 6.24 |
| Set 3 | 90.11 | 0.69 | 6.73 | 66.05 | 15.59 | 37.51 |
| Set 4 | 90.02 | 0.68 | 7.11 | 85.40 | 1.87 | 26.25 |

Remarks
L* indicates the level of lightness or darkness of the samples. a* indicates the red or green coordinate and b* indicates the yellow or blue coordinates. Based on table 9, results indicates that the outward appearance of the gloves changed from white colour to brown colour for all glove samples. L* indicates the lightness of the glove colour, wherein a higher value indicates a lighter coloured glove. As the concentration of the additive increases, the white color of the glove decreases. The values obtained after aging for L* also exhibited further deterioration of white colour for sets 3 to sets 5.
Besides that, positive b* value indicates yellow or blue colour and the higher the value, the darker the yellow colour observed. This shows a similar trend to L*, wherein a higher concentration gives a darker yellow glove. All glove samples exhibited high level of browning as shown by the high values of b* in table 9 due to oxidative thermal degradation.

Separately, Table 10 shows the outcome of mechanical properties (i.e. tensile strength and elongation at break) for conventional glove and glove of the present invention having 0.5 phr potassium permanganate as additive of the present invention as discussed in the second aspect in accordance to the ASTM D6319 standard. The aging condition is carried out at 70° C. for 7 days.

TABLE 10
Mechanical properties of glove samples

| | Tensile | | Elongation | |
|---|---|---|---|---|
| | strength (MPa) | | at break (%) | |
| | Before | After | Before | After |
| Samples | aging | aging | aging | aging |
| Conventional glove | 35.97 | 40.68 | 597.78 | 498.42 |
| Glove of the present | 35.11 | 42.07 | 614.11 | 607.63 |
| invention | | | | |

| | | | |
|---|---|---|---|
| Standard requirement | Min. 14 | Min. 500 | Min. 400 |

Based on the table above, it is evident that the glove of the present invention having the additive solution of the present invention meets the standard requirement for both elongation at break and tensile strength.

As a whole, the additive of the present invention is able to produce nitrile gloves exhibiting desirable chemical permeation resistance properties as well as physical appearance without compromising the mechanical properties.

The terminology used herein is for the purpose of describing particular example embodiments only and is not intended to be limiting. As used herein, the singular forms “a”, “an” and “the” may be intended to include the plural forms as well, unless the context clearly indicates otherwise. The terms “comprises”, “comprising”, “including”, and “having” are inclusive and therefore specify the presence of stated features, integers, steps, operations, elements, and/or components, but do not preclude the presence or addition of one or more other features, integers, steps, operations, elements, components, and/or groups therefrom.

The method steps, processes, and operations described herein are not to be construed as necessarily requiring their performance in the particular order discussed or illustrated, unless specifically identified as an order of performance. It is also to be understood that additional or alternative steps may be employed. The use of the expression “at least” or “at least one” suggests the use of one or more elements, as the use may be in one of the embodiments to achieve one or more of the desired objects or results.

1. A latex formulation having an additive comprising:
a manganese based compound, wherein the manganese in the additive is with valency of +2 or +7,
wherein the additive having the manganese with valency +2 is used in an amount ranging between 0.005 phr to 30.0 phr; and
wherein the additive having the manganese with valency +7 is used in an amount ranging between 0.25 phr to 10.0 phr.

2. The latex formulation as claimed in claim 1, wherein the manganese based compound is either potassium permanganate or manganese carbonate.

3. A latex formulation having an additive comprising:
a manganese based compound, wherein the manganese based compound is used in an amount ranging between 5.0 wt % to 40.0 wt % of the additive;
a wetting agent, wherein the wetting agent is used in an amount ranging between 1.0 wt % to 5.0 wt % of the additive;
a dispersing agent, wherein the dispersing agent is used in an amount ranging between 0.02 wt % to 2.0 wt % of the additive;
a thickener, wherein the thickener is used in an amount ranging between 3.0 wt % to 15.0 wt % of the additive; and
water, wherein the water is used in an amount ranging between 38.0 wt % to 90.98 wt % of the additive.

4. The latex formulation as claimed in claim 3, wherein the additive is used in an amount ranging between 0.005 phr to 30.0 phr.

5. The latex formulation as claimed in claim 3, wherein the manganese based compound is manganese carbonate.

6. The latex formulation as claimed in claim 3, wherein the manganese based compound is used in an amount ranging between 15.0 wt % to 30.0 wt % of the additive.

7. The latex formulation as claimed in claim 3, wherein the wetting agent is used in an amount ranging between 1.0 wt % to 4.0 wt % of the additive.

8. The latex formulation as claimed in claim 3, wherein the wetting agent is selected from the group consisting of non-ionic wetting agents, anionic wetting agents, ethoxylates of alcohol, and mixtures thereof.

9. The latex formulation as claimed in claim 3, wherein the dispersing agent is used in an amount ranging between 0.02 wt % to 2.0 wt % of the additive.

10. The latex formulation as claimed in claim 3, wherein the dispersing agent is selected from the group consisting of non-ionic dispersing agents and anionic dispersing agents.

11. The latex formulation as claimed in claim 3, wherein the thickener is used in an amount ranging between 5.0 wt % to 7.0 wt % of the additive.

12. The latex formulation as claimed in claim 3, wherein the thickener is selected from the group consisting of xanthan gum, guar gum, bentonite, and mixtures thereof.

13. The latex formulation as claimed in claim 3, wherein the water is used in an amount ranging between 58.9 wt % to 78.98 wt % of the additive.

14. The latex formulation as claimed in claim 3, wherein the water is soft water.

15. A glove is prepared from a latex formulation as claimed in claim 1.
